(19) United States
(12) Patent Application Publication
(10) Pub. No.: US 2025/0108909 A1
(43) Pub. Date: Apr. 3, 2025

(54) Low Drag Nacelle and Pylon Fairing

(71) Applicant: Textron Aviation Inc., Wichita, KS (US)

(72) Inventors: Kelly Ray Laflin, Andover, KS (US); Robert Glynn Wiegers, Wichita, KS (US)

(21) Appl. No.: 18/477,984

(22) Filed: Sep. 29, 2023

(51) Int. Cl. B64C 7/02; B64C 21/04; B64D 27/20; B64D 27/26

(52) U.S. Cl. CPC B64C 7/02; B64C 21/04; B64D 27/20; B64D 27/40

(57) ABSTRACT

A low drag nacelle and pylon fairing for an aircraft includes a fairing configured to provide a low drag connection between a pylon and a nacelle. The fairing includes an aft-facing face formed between the nacelle and a trailing edge of the pylon with the aft-facing face being configured with a vent for exhausting air in the same direction as engine jet exhaust flow. The fairing includes aerodynamically formed curves providing a larger aft-facing face compared with traditional fairing arrangements. A substantial improvement in drag reduction is achieved by venting air into the space immediately beyond the aft-facing face.

### BACKGROUND OF THE INVENTION

### 1. Field

The disclosed embodiments relate generally to the field of aircraft. More specifically, the disclosed embodiments relate to the nacelle and pylon on aircraft

### 2. Description of the Related Art

It is known for an aircraft to have an attachment which attaches an engine to a forward wing on an aircraft. For example, in U.S. Pat. No. 8,006,931 to Dantin et al. describes a strut with an aerodynamic shape and a filleted fairing connecting forward and rear aerodynamic structures.

It is also known for an aircraft to have a movable chine on the nacelle of an aircraft to manage airflow. For example, in U.S. Pat. No. 8,087,617 to Sclafani et al. describes a movable chine to shift an engine nacelle in order to delay flow separation induced by the engine nacelle. The movable chine may be installed on rearward or forward wings of an aircraft.

It is also known for an aircraft to have a movable pylon to allow the angle of an aircraft engine to be changed based upon different stages of flight. For example, in U.S. Pat. No. 8,240,600 to Balk et al. describes an engine movable relative to the wing during different phases of flight to reduce aerodynamic drag.

It is also known for an aircraft to have a nacelle for an aircraft engine which allows the engine to ingest boundary layers of air formed by the aircraft. For example, in U.S. Patent Application Publication No. 2019/0283891 to Colmagro et al. describes a fan within a duct positioned downstream of the engine. The struts may be eliminated and replaced with the link of the driveshaft and the engine output shaft and fixed blades.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

In an embodiment, a low drag nacelle and pylon fairing for an aircraft includes: a fairing having an aft-facing façade, wherein the fairing is configured to aerodynamically couple an engine nacelle to a trailing edge of a pylon; and a vent disposed in the aft-facing façade, wherein the vent is configured to exhaust air into a space aft of the fairing, wherein the exhaust is directionally parallel with exhaust flow from the engine.

In yet another embodiment, a method for exhausting air from a fairing for reducing airflow separation about the fairing during flight of an aircraft includes: providing a vent on a face of a fairing, wherein the fairing aerodynamically couples an engine nacelle to a trailing edge of a pylon and the face is aft-facing; exhausting air from the vent, wherein the air is exhausted directionally parallel with an airstream during flight of an aircraft.

### BRIEF DESCRIPTION OF SEVERAL VIEWS OF THE DRAWINGS

Illustrative embodiments are described in detail below with reference to the attached drawing figures, which are incorporated by reference herein and wherein:

FIG. 1A shows a top perspective view of an aircraft for the low drag nacelle and pylon fairing;

FIG. 1B shows a front perspective view of an aircraft for the low drag nacelle and pylon fairing;

FIG. 1C is a close up top perspective view of FIG. 1A for the low drag and nacelle pylon fairing;

FIG. 2 shows an aft-perspective view of the low drag nacelle and pylon fairing;

FIG. 3 shows an alternate perspective view of the low drag nacelle and pylon fairing and;

FIG. 4 shows a perspective view of the low drag nacelle and pylon fairing in an alternative embodiment.

FIG. 5A shows a perspective view of the lower surface of an aircraft pylon with a streamline schematic view of a prior method used to exhaust air;

FIG. 5B shows a perspective view of the upper surface of an aircraft pylon with a streamline schematic view of a prior method used to exhaust air;

FIG. 6A shows a perspective view of the lower surface of an aircraft pylon with a streamline schematic view of the low drag nacelle and pylon fairing, and;

FIG. 6B shows a perspective view of the upper surface of an aircraft pylon with a streamline schematic view of the low drag nacelle and pylon fairing.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

Embodiments disclosed herein provide a system for reducing drag generated from the nacelle and pylon structure of an engine located on an aircraft pylon. In prior art arrangements, significant amounts of drag are caused by the fairing that connects the nacelle and pylon lofts. In some arrangements, when exhaust from the aircraft system air cooled heat exchanger is vented out from the side or lower-side surface of the pylon, airflow lines near the bottom surface of the pylon are separated which generates drag. The spent cooling air may be vented out through the trailing edge of the pylon to reduce drag, but this arrangement creates back pressure in the heat exchanger cooling circuit, which decreases the overall performance of the associated aircraft system to be suboptimal. A solution is needed which allows for the spent cooling air to be exhausted, while not generating additional drag, or reducing the effectiveness of the associated aircraft system. Compared with prior art arrangements, a system is needed which reduces the drag between the nacelle and pylon lofts.

Within embodiments, a low drag nacelle and pylon fairing system allows for drag generated by nacelle and pylon loft to be substantially reduced. In embodiments, the engine nacelle is mounted on a pylon. The pylon is mounted to the fuselage of an aircraft. Without a fillet or fairing, the nacelle and pylon structures intersect at near a ninety-degree angle which may generate drag. The fairing may be constructed and secured around the structure supporting and mounting the nacelle to the pylon. Drag may be substantially reduced by creating an optimized fairing between the pylon and nacelle skin. The fairing may be created with a shape to enhance the aerodynamics and substantially link the pylon and nacelle structure together. In some embodiments, the fairing may be structurally secured to the pylon with a seal created between the fairing and nacelle to allow for relative movement of the nacelle and fairing-pylon during flight. In other embodiments it is possible for the fairing to be structurally secured to the nacelle and with a seal created between the fairing and pylon to allow for relative movement of the nacelle-fairing and pylon during flight. In embodiments, the low drag and nacelle pylon fairing is not designed to be the primary load bearing structure in supporting the pylon and nacelle structure. The optimized fairing may have a larger aft face than on current arrangements so that a vent may be placed directly on the aft face. The vent may be used to exhaust air from the aircraft system heat exchanger. By exhausting the heat exchanger spent air through the aft face, the spent air is able to substantially fill the region and reduce drag on the aft facing base area of the pylon nacelle fairing.

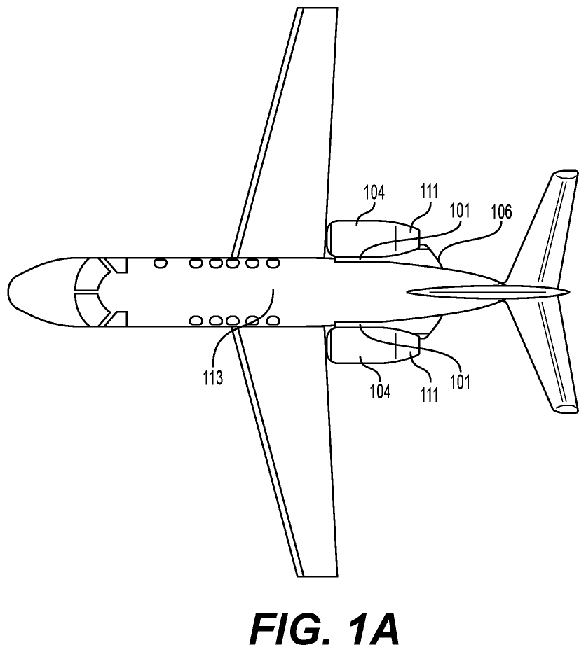

FIG. 1A is a top view and FIG. 1B is a front view of an aircraft with a nacelle 104 mounted onto a pylon 101 mounted to an aircraft fuselage 113. FIG. 1A shows the pylon 101 connecting the nacelle 104 to the aircraft fuselage 113. In FIG. 1B, the pylon 101 and the nacelle 104 are joined together at an approximate ninety-degree angle such that the pylon 101 juts away from the nacelle 104 near its center.

FIG. 1C shows a close-up perspective view of FIG. 1A. The pylon 101 spans substantially along the nacelle 104 and extends slightly beyond the nozzle 111 of the nacelle 104 and substantially connects the nacelle 104 to the fuselage 113 of the aircraft.

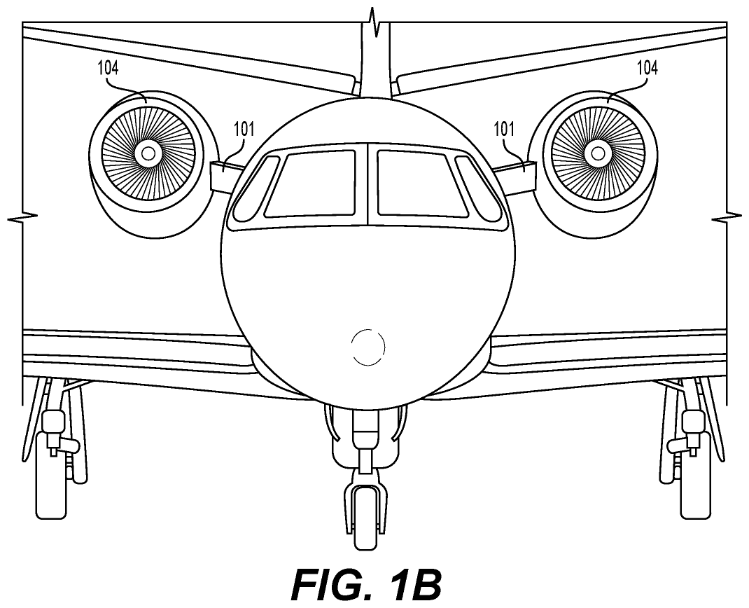

FIG. 2 shows an aft perspective view of the low drag nacelle pylon fairing 100. The pylon fairing 100 has an aft-facing face 102. The aft-facing face 102 is configured to be substantially triangular in shape with three vertices, 108, 109, and 110, and three sides 103, 105, and 107. The aft-facing face 102 may be referred to in embodiments as an aft-facing façade. A first side 105 extends between a first vertex 108 and a second vertex 109. A second side 107 extends between the first vertex 108 and a third vertex 110. A third side 103 extends between the second vertex 109 and the third vertex 110. The third vertex 110 is aerodynamically coupled with a pylon edge 106, meaning that the fairing 100 provides a smooth transition to the pylon edge 106 with a continuous curvature so as to avoid any sharp corners that might cause airflow separation. The pylon edge 106 is the trailing edge of the pylon which may be seen in FIG. 1C. In embodiments, the pylon edge 106 comprises a blunt edge compatible with manufacturing methods known to one of skill in the art.

The first side 105 of the aft-facing face 102 is shaped to substantially conform to the nacelle 104, while the second side 107 extends the pylon edge 106 to a lower portion of the nacelle 104. A third side 103 extends the pylon edge 106 to an upper portion of the nacelle 104. Both the third side 103 and the second side 107 meet at the third vertex 110 on the pylon edge 106. All three of the sides 103, 105, 107 have a concave curvature having an arc (e.g., a semicircular geometry). In embodiments, the curvature and shape of the second side 107 is substantially similar to, and possibly symmetrical with, the curvature and shape of the third side 103. The curvature and shape of the first side 105 and the third side 103 of the fairing 100 aerodynamically couple the nacelle 104 to the pylon edge 106. The fairing 100 does not serve as a primary support member for the weight of the nacelle 104 or the thrust loads and weight induced by the engine.

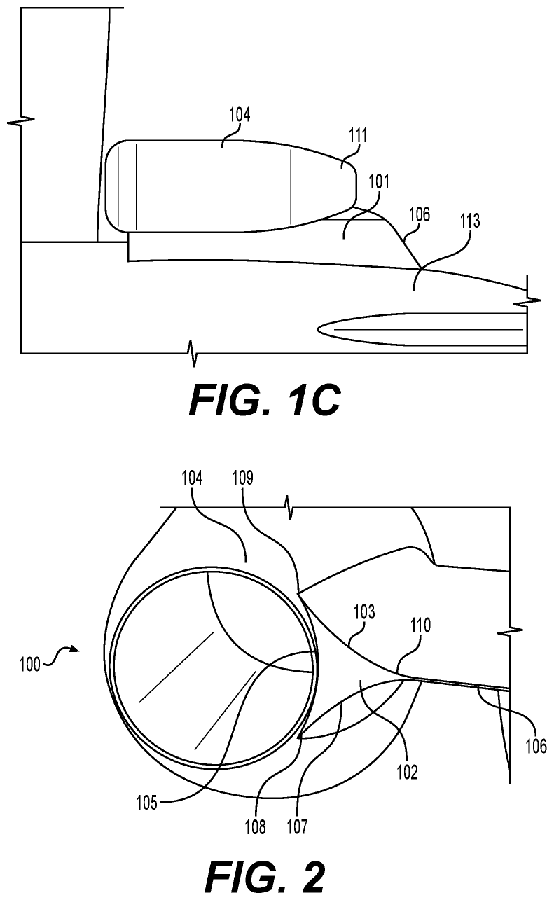

FIG. 3 shows an alternate perspective view of the pylon fairing 100. The aft-facing face 102, or façade, is substantially planar. The curvature of the second side 107 and the third side 103 allow the fairing 100 to slope from above and below the pylon edge 106 in a smooth manner with continuous curvature to avoid any sharp corners. The pylon trailing edge 106, in some embodiments, may be blunt with a finite thickness and base area for manufacturing purposes.

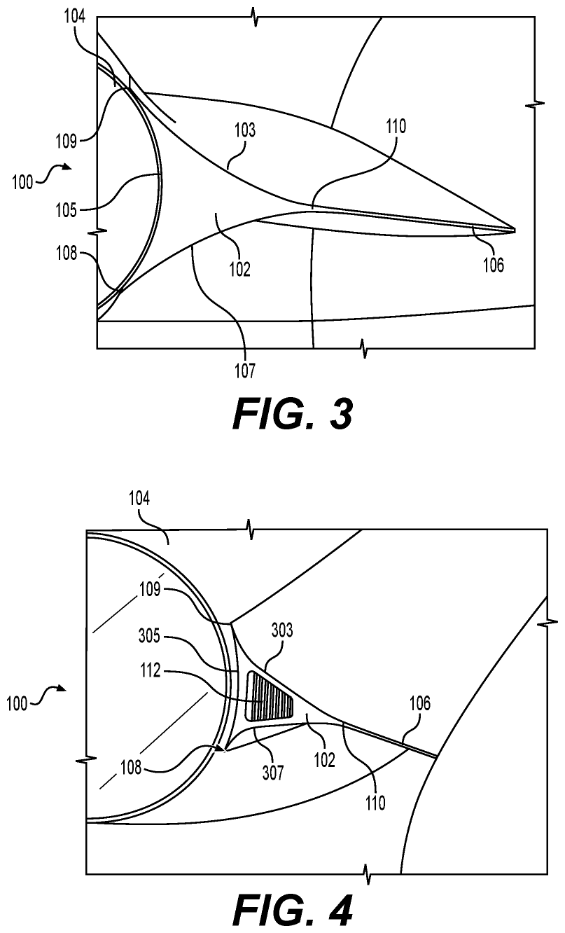

FIG. 4 shows a perspective view of an alternative embodiment of the fairing 100 including a vent 112. The aft-facing face 102 includes a first side 303, a second side 305, and a third side 307. The sides 303, 305, and 307 are arranged similarly to the sides 103, 105, and 107 included in the embodiment disclosed in FIG. 1. The curvature of the sides 303, 305, and 307 is such which allows the pylon edge to be aerodynamically coupled to the nacelle 104. The first and second sides 303 and 307 begin substantially near each other on the pylon edge 106 and proceed to flow away from one another with opposing curvature towards the nacelle 104. The curvature of the first side 303 and the second side 307 is such which allows for the fairing 100 to be aerodynamic. The third side 305 substantially conforms to the nacelle 104. The vent 112 is configured on the aft-facing face 102 and is configured to exhaust air from an aircraft system heat exchanger. The jet engine exhaust released from the nozzle 111 of the nacelle 104 also induces air to flow out from the vent 112 and may substantially increase the effectiveness of the vent 112. Air exhausted through the vent 112 is configured to add airflow behind the face 102 surface and is vented directionally parallel to the jet flow. Exhausting air through the vent 112 in this region may substantially reduce the drag experienced by the aircraft. Specifically, the addition of air exhausted from the vent 112 substantially reduces the base drag associated with the aft facing surface 102. Additionally, the relocation of the vent to the face 102 surface from the standard pylon lower surface location 502 provides an additional drag benefit, as it removes the occurrence of vent induced boundary layer separation 506 on the pylon lower surface. The jet exhaust exhausted from the nozzle 111 may establish a current and allow air to be drawn from the vent 112. In embodiments the vent 112 may be configured to exhaust air from the heat exchanger in other embodiments air from other aircraft systems may be exhausted through the vent 112. The vent 112 is shown in embodiments to be positioned substantially near the center of the face 102 and has a substantially trapezoidal geometry configured to fit on the face 102.

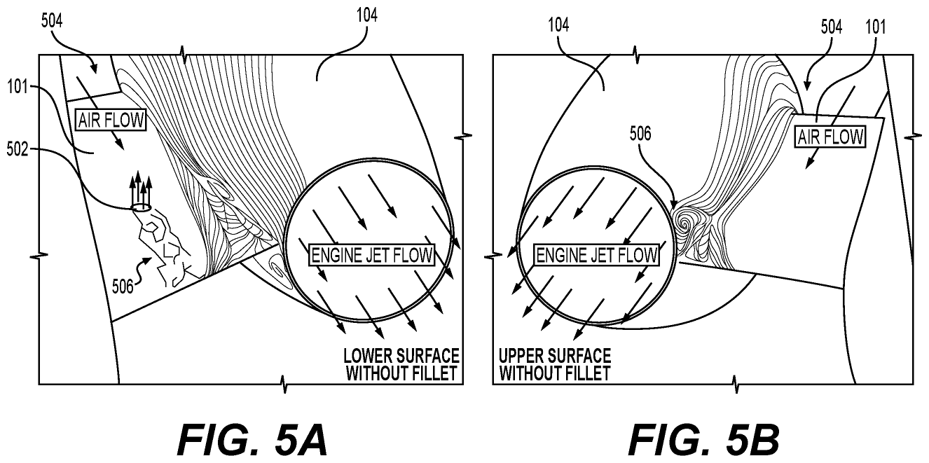

FIG. 5A and FIG. 5B show a prior method of exhausting air from a vent 502. FIG. 5A and FIG. 5B may be created using a fluid modeling software, such as a Reynolds-average Navier-Stokes (RANS) solver, to show streamlines of air flowing over the surfaces of the pylon 101 while the aircraft is in flight. FIG. 5A shows the lower surface of the pylon 101 where the vent 502 is configured to exhaust air from the downward facing surface of the pylon 101. The venting of air from this position on the pylon 101 causes the flow of vented air to be perpendicular to the streamlines 504 representing air flowing over the pylon 101 while the aircraft is in flight. The streamlines 504 may also represent a boundary layer. The air exhausted from the vent 502 causes the streamlines 504 to become separated which creates separation drag 506. The separation drag 506 appears as eddies that form downstream from the vent 502. The separation of the streamlines 504 may be a boundary layer becoming detached which may induce drag. The air exhausted from the vent 502 may also have an elevated temperature which may cause discoloration on the surface of the pylon 101 downstream of the vent 502.

FIG. 5B shows the upwards facing surface of the pylon 101. The separation drag 506 is shown around the trailing edge of the pylon 101 substantially near where the pylon 101 and the nacelle 104 are joined.

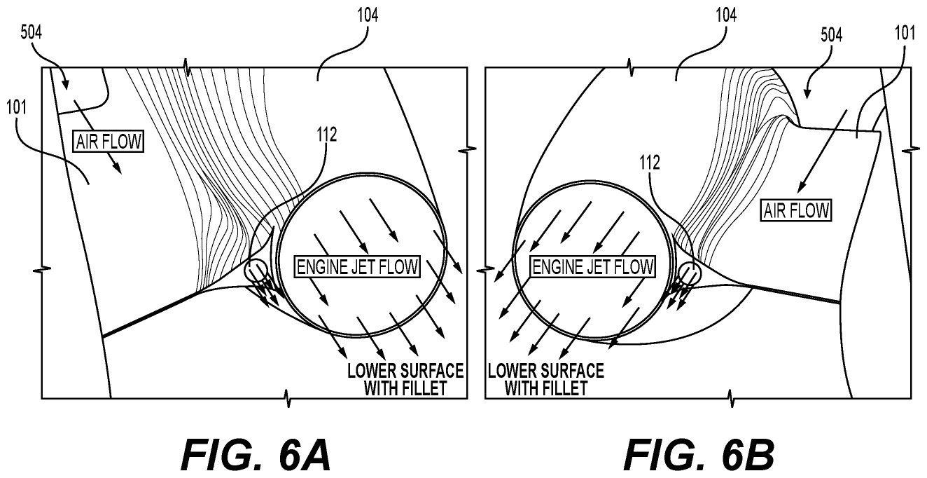

FIG. 6A and FIG. 6B show the fairing 100 disclosed in embodiments. FIG. 6A and FIG. 6B may be created using a fluid modeling software to show streamlines of air flowing over the surfaces of the pylon 101 while the aircraft is in flight. In FIG. 6A the streamlines 504 are shown to flow over the fairing 100 substantially smoothly which indicates that the drag experienced by the pylon 101 is substantially reduced from the prior method of FIG. 5A and FIG. 5B. The fairing 100 may substantially keep the boundary layer attached (i.e. the streamlines 504 remain substantially parallel to each other and to the fairing 100.) which may reduce drag. In FIG. 6A the vent 112 vents or exhausts air parallel to the jet flow which reduces drag. The fairing 100 is configured with aerodynamic geometry to keep the boundary layer (e.g. streamlines 504) attached which thereby reduces drag.

FIG. 6B shows the upper facing surface of the pylon 101. The vent 112 is configured on the aft-facing face 102 of the fairing 100 and exhausts air in the downstream direction with the engine jet flow. This allows for the separation drag 506 to be substantially reduced as indicated by the smoothly flowing streamlines 504.

The fairing 100 for the low drag nacelle pylon may be configured on numerous different types of aircraft pylon structures. One such pylon the fairing 100 for the low drag nacelle pylon may be mounted on is rear or aft mounted pylons positioned aft on an aircraft. Alternatively, the fairing 100 for the low drag nacelle pylon may be configured on pylons configured at other positions on an aircraft. The fairing 100 may be fabricated from aluminum or a carbon composite material, or a similar material, in embodiments.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

1. A low drag nacelle and pylon fairing for an aircraft comprising:
a fairing having an aft-facing façade, wherein the fairing is configured to aerodynamically couple an engine nacelle to a trailing edge of a pylon; and
a vent disposed in the aft-facing façade, wherein the vent is configured to exhaust air into a space aft of the fairing, wherein the exhaust is directionally parallel with exhaust flow from the engine.

2. The low drag nacelle and pylon fairing of claim 1 wherein the vent is configured to exhaust air from an aircraft system heat exchanger.

3. The low drag nacelle and pylon fairing of claim 1 wherein the aft-facing façade is adjacent to the trailing edge of the pylon, and a shape of the aft-facing façade comprises a continuous curvature configured to smoothly connect with the trailing edge.

4. The low drag nacelle and pylon fairing of claim 1 wherein the fairing has a first vertex, a second vertex, and a third vertex, wherein the first vertex and the second vertex provide a smooth connection to the engine nacelle and the third vertex provides a smooth connection to the trailing edge of the pylon.

5. The low drag nacelle and pylon fairing of claim 4 comprising a first side extending between the first vertex and the second vertex, wherein the first side conforms to a curved profile of the engine nacelle.

6. The low drag nacelle and pylon fairing of claim 1 wherein the fairing is fabricated from aluminum or a carbon composite.

7. The low drag nacelle pylon fairing of claim 1, wherein the pylon is mounted on an aft portion of a fuselage of an aircraft.

8. The low drag nacelle pylon fairing of claim 1, wherein the fairing comprises shape having smooth continuous curvature configured to maintain a boundary layer of airflow attached to a surface of the fairing thereby reducing aerodynamic drag.

9. The low drag nacelle pylon fairing of claim 1, wherein the vent is disposed substantially in a center of the aft-facing façade.

10. The low drag nacelle pylon fairing of claim 1, wherein the vent comprises a substantially trapezoidal geometry configured to fit a shape of the aft-facing façade.

11. A method for exhausting air from a fairing for reducing airflow separation about the fairing during flight of an aircraft, the method comprising:
providing a vent on a face of a fairing, wherein the fairing aerodynamically couples an engine nacelle to a trailing edge of a pylon and the face is aft-facing;
exhausting air from the vent, wherein the air is exhausted directionally parallel with an airstream during flight of an aircraft.

12. The method of claim 11, wherein exhausting air comprises exhausting air from an aircraft system heat exchanger.

13. The method of claim 11 wherein exhausting air from the vent maintains boundary layer airflow on the fairing and reduces airflow separation thereby reducing aerodynamic drag.

14. The method of claim 11, wherein exhausting air from the vent substantially reduces airflow separation on a bottom surface of the pylon compared to a vent located on the bottom surface of the pylon.

15. The method of claim 11, wherein exhausting air from the vent comprises exhausting air directionally parallel with engine exhaust from a jet engine nozzle.
